(19) United States
(12) Patent Application Publication
(10) Pub. No.: US 2015/0015097 A1
(43) Pub. Date: Jan. 15, 2015

(54) CONDUCTION-COOLED SUPERCONDUCTING ROTATING MACHINE

(71) Applicants: Hyun Jang Shin, Yongin-si Gyeonggi-do (KR); Keun Woong Kim, Yongin-si Gyeonggi-do (KR); Jae Nam Bae, Seongnam-si Gyeonggi-do (KR)

(72) Inventors: Hyun Jang Shin, Yongin-si Gyeonggi-do (KR); Keun Woong Kim, Yongin-si Gyeonggi-do (KR); Jae Nam Bae, Seongnam-si Gyeonggi-do (KR)

(73) Assignee: HYUNDAI HEAYV INDUSTRIES CO., LTD., Ulsan (KR)

(21) Appl. No.: 14/382,766

(22) PCT Filed: Jul. 4, 2012
(86) PCT No.: PCT/KR2012/005311

§ 371 Date: Sep. 4, 2014

(30) Foreign Application Priority Data
Mar. 7, 2012 (KR) 10-2012-0023465

(51) Int. Cl. H02K 55/00; H02K 9/10; H02K 9/22

(52) U.S. Cl. CPC H02K 55/00; H02K 9/22; H02K 9/10
USPC 310/57

(57) ABSTRACT

Disclosed is a conduction cooling type superconducting rotator which includes a cryocooler, a rotary shaft including a columnar hall being spaced apart from the cryocooler to enclose the cryocooler and the rotary shaft configured to transfer a rotary power, a vacuum chamber including columnar halls arranged at both sides of the rotary shaft, first and second heat transfer elements being connected with the cryocooler and a heat transfer unit conducting a heat to the cryocooler through the first and second heat transfer elements wherein inner surfaces of the columnar halls and outer surfaces of the rotary shaft connectedly rotates and first and second cooling units configured to connect the first and second heat transfer elements and the cryocooler and the vacuum chamber is sequentially cooled in the first and second cooling unit.

### TECHNICAL FIELD

This application relates to a conduction cooling type superconducting rotator and more particularly to a conduction cooling type superconducting rotator including a cryocooler therein to simplify an outside refrigerant flow line and decrease thermal losses therethrough and shortening a distance between a cyrocooler and a superconductive wire material to enable conduction cooling.

### BACKGROUND ART

In general, a superconducting rotator uses a superconductor in a field coil of a generator or a motor and the superconductor corresponds to a conductor illustrating superconducting phenomenon where an electric resistance reaches a value of 0 in a very low temperature. In the superconductor, when a temperature is increased, the electric resistance is increased and a current flow is decreased and when the temperature is decreased, the electric resistance is decreased and conduction well transferred. Specially, the superconductor corresponds to a material where its electric resistance reaches a value of 0 when the temperature is decreased to an extremely low temperature. Herein, the extremely low temperature is a temperature range being less than or equal to an absolute temperature 4K, in the extremely low temperature, an agitation by a thermal motion is small so that a basic motion aspect of a particle in the material is clear. Thereby, an extremely low temperature technology is used to a measurement of a material property for a semiconductor or a magnetic substance. A development of the extremely low temperature technology is largely related to a superconducting technology and the extremely low temperature technology is used to an extensive field such as energy, an electric technology, a medical science and physics. A generator or motor using the superconductor have advantages including a miniaturization and lightening, an efficiency increase, a stability increase of a power system and a decrease of a manufacturing cost.

In a conventional superconducting rotator, a refrigerant cooled outside is flowed in a superconducting rotator and the cooled refrigerant flows through a flow path in the superconducting rotator to cool the superconducting rotator. A structure of the conventional superconducting rotator generates a thermal loss in a complicated flow path formed outside. Further, a circulator and the flow path flowing the refrigerant are installed in the conventional superconducting rotator thereby a structure thereof may be complicated and a fault generating factor may be increased.

Korean Patent Registration No. 10-1042013 relates to a superconducting rotator, that is, a cooling structure for cooling a fixable element of a superconductive motor or a generator. The cooling structure cools the fixable element of the superconducting rotator where a fixable element coil thereof is fixed by a slot and a fixable element yoke thereof is formed on an outer of the fixable coil. The cooling structure is characterized in that the fixable element coil has a space unit toward an axis direction in the slot so that a part of the fixable element coil is exposed and a cooling tube is arranged between the exposed part of the fixable element coil and the fixable element yoke thereby the cooling structure simultaneously cools the fixable element coil and the fixable element yoke. Therefore, the cooling tube is in touch with both of the fixable element coil and the fixable element yoke to cool both of the fixable element coil and the fixable element yoke, prevent cooling tube clogging because the cooling tube spirally winds the fixable element coil, simplify manufacturing and supporting a very large electromagnetic force being generated in a ship propulsion motor or a wind power generator having low speed and high torque.

Korean Patent Publication No. 10-2010-0044393 relates to a superconductive motor with an armature coil cooling unit and the superconductive motor includes a rotator coiling a superconducting field coil and a fixable element forming an armature slot holding a plurality of armature coil. A cooling channel is bond formed in a one side of the armature coil, the cooling channel absorbing a generated heat of the armature coil. The cooling channel may be formed of a stainless steel or a copper alloy, that is, a material having a non-resistance being relatively larger than that of the armature coil and a thermal conductivity being higher than that of the armature coil. Therefore, the superconductive motor having a cooling means of the armature coil forms a cooling channel in one side of the armature coil to directly absorb the heat without passing a surrounding air, the heat being generated by an eddy current generated in the armature coil. Further, because the cooling channel may be formed of a stainless steel or a copper alloy having a non-resistance being relatively larger than that of the armature coil and a thermal conductivity being higher than that of the armature coil, and may be not influenced by an eddy current generated in the armature coil the superconductive motor may minimize heat loss generated in the cooling channel and may absorb the heat generated by the armature coil

### Technical Problem

Embodiments of the present invention propose to provide a conduction cooling type superconducting rotator including a cyrocooler therein to simplify a refrigerant flow path and decreasing a thermal loss through a simplification of a refrigerant flow path.

Embodiments of the present invention propose to provide a conduction cooling type superconducting rotator shortening a distance between a cyrocooler and a superconductive wire material to enable conduction cooling.

### Technical Solution

In some embodiments, a conduction cooling type superconducting rotator includes a cryocooler, a rotary shaft including a columnar hall being spaced apart from the cryocooler to thereby enclose the cryocooler and the rotary shaft configured to transfer a rotary power, a vacuum chamber including columnar halls arranged at both sides of the rotary shaft, first and second heat transfer elements being connected with the cryocooler and a heat transfer unit conducting a heat to the cryocooler through the first and second heat transfer elements wherein inner surfaces of the columnar halls and outer surfaces of the rotary shaft connectedly rotates and first and second cooling units configured to connect the first and second heat transfer elements and the cryocooler.

In one embodiment, each of the first and second heat transfer elements may be curvedly formed toward first and second directions in the vacuum chamber, may mainly include a copper as a conductor and may cool the vacuum chamber.

In one embodiment, the vacuum chamber may further include a rotary power transfer element, a plurality of radial wheel units and a yoke unit, the rotary power transfer element being connected with the rotary shaft, the plurality of the radial wheel units being connected with the rotary power transfer element, the yoke unit being connected with the plurality of the radial wheel units, may further include a superconductive wire material being arranged toward outside of the yoke unit in the vacuum chamber and being horizontally spaced apart from one side of each of the first and second heat transfer elements, the superconductive wire material being conductively cooled through each of the first and second heat transfer elements and may be sequentially cooled in the first and second cooling unit, the first and second cooling unit being connected with the first and second heat transfer elements and the cryocooler

### Technical Effects

The conduction cooling type superconducting rotator according to an example embodiment of the present invention may include a cyrocooler therein to simplify a refrigerant flow path and may decrease a thermal loss through a simplification of a refrigerant flow path.

The conduction cooling type superconducting rotator according to an example embodiment of the present invention may shorten a distance between a cyrocooler and a superconductive wire material to enable conduction cooling.

### DESCRIPTION OF DRAWINGS

FIG. 1 is a cross sectional diagram illustrating a conduction cooling type superconducting rotator according to an example embodiment of the present invention.

FIG. 2 is a perspective diagram illustrating a conduction cooling type a superconducting rotator in FIG. 1.

FIG. 3 is a diagram illustrating a cryocooler according to an example embodiment of the described technology.

| | |
|---|---|
| 110: CRYOCOOLER | 111: REGENERATOR |
| 112: COMPRESSER | 113: MOVABLE MOTOR |
| 114: INTAKE VALVE | 115: DISCHARGE VALVE |
| 116: CYLINDER | 120: ROTARY SHAFT |
| 130: VACUUM CHAMBER | 131: FIRST HEAT |
| | TRANSFER ELEMENT |
| 132: SECOND HEAT | 133: ROTARY POWER |
| TRANSFER ELEMENT | TRANSFER ELEMENT |
| 134: A PLURALITY OF RADIAL | 135: YOKE UNIT |
| WHEEL UNITS | |
| 136: SUPERCONDUCTIVE | 140: HEAT TRANSFER |
| WIRE MATERIAL | UNIT |
| 141: FIRST COOLING UNIT | 142: SECOND COOLING UNIT |

### MODE FOR INVENTION

The embodiments and the configurations depicted in the drawings are illustrative purposes only and do not represent all technical scopes of the invention, so it should be understood that various equivalents and modifications may exist at the time of filing this application. Although a preferred embodiment of the disclosure has been described for illustrative purposes, those skilled in the art will appreciate that various modifications, additions and substitutions are possible, without departing from the scope and spirit of the invention as disclosed in the accompanying claims.

Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component. For instance, the first component may be referred to the second component and vice versa without departing from the right of the disclosure.

When a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

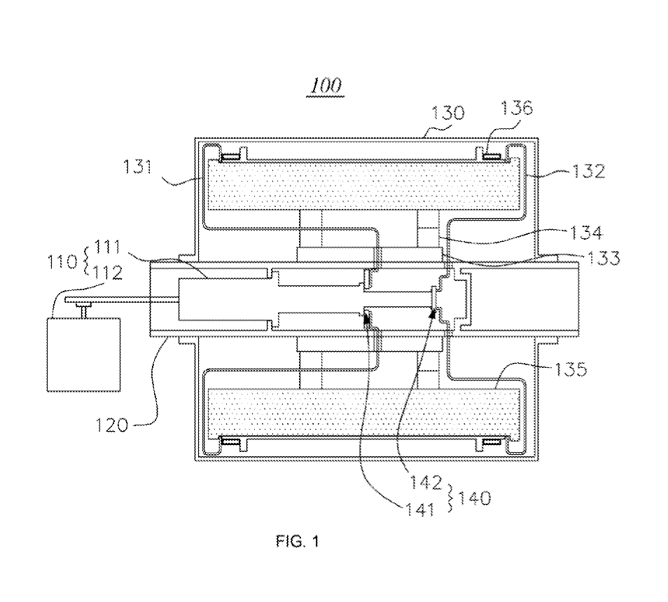

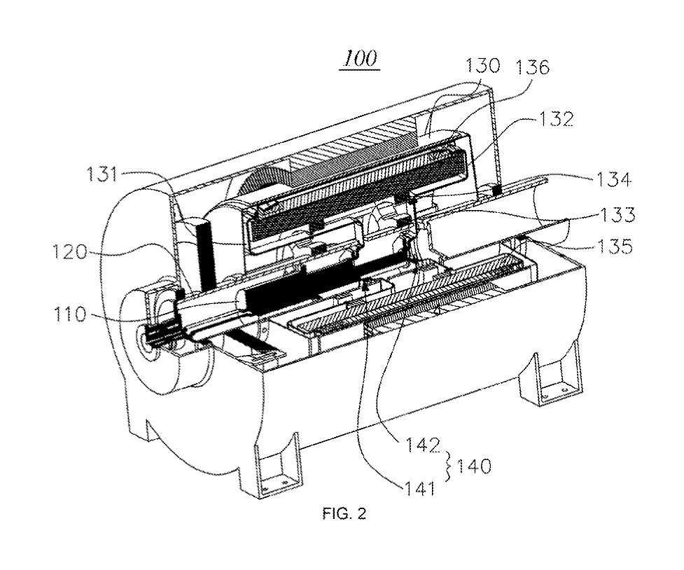

FIG. 1 is a cross sectional diagram illustrating a conduction cooling type superconducting rotator according to an example embodiment of the present invention and FIG. 2 is a perspective diagram illustrating a conduction cooling type a superconducting rotator in FIG. 1.

Referring to FIG. 1, a conduction cooling type the superconducting rotator 100 includes a cryocooler 110, a rotary shaft 120, a vacuum chamber 130 and a heat transfer unit 140.

The cryocooler 110 includes a cylindrical shaped regenerator 111 having three stages and a compressor 112 being arranged outside. A circumference of the regenerator 111 is decreased from a first stage to a third stage via a second stage. In one embodiment, the compressor 112 may compress a refrigerant with a high pressure and the compressed refrigerant may flow in the regenerator 111 to be expanded with a low pressure thereby the expanded refrigerant absorbs a surrounding heat to implement an extremely low temperature.

The rotary shaft 120 includes a columnar hail being spaced apart from the cryocooler 110 to enclose the cryocooler 110. In one embodiment, an inner projection of the rotary shaft 120 may be combined with an outer projection of the cryocooler 110. Further, the rotary shaft 120 transfers a rotary power generated from an outer motor (unshown). The rotary shaft 120 may rotate the cryocooler 110 though the combination.

The vacuum chamber 130 includes columnar halls arranged at both sides and an inner surfaces of the columnar halls and outer surfaces of the rotary shaft 120 are combined. In one embodiment, the vacuum chamber 130 rotates with the rotary shaft 120 through the combination with the rotary shaft 120. Further, an inner of the vacuum chamber 130 may be formed with a vacuum. In one embodiment, the vacuum chamber 130 includes first and second heat transfer elements 131 and 132 being connected with the cryocooler 110 and a heat transfer unit 140 conducting a heat to the cryocooler 110 through the first and second heat transfer elements 131 and 132. The first and second heat transfer elements 131 and 132 and the cryocooler 110 may be sequentially cooled in first and second cooling units 141 and 142. In one embodiment, the first heat transfer element 131 may be curvedly formed toward a first direction and the second heat transfer element 132 may be curvedly formed toward a second direction. Further, the first and second heat transfer elements 131 and 132 mainly include a copper as a conductor and conduct the heat to cool the vacuum chamber 130. In one embodiment, the first and second heat transfer elements 131 and 132 may be formed with a copper where the copper has heat conductivity higher than that of an iron or a manganese among a plurality of pure metals and is not deformed in a high temperature and may use an oxygen-free copper being easily processed at a room temperature.

The vacuum chamber 130 further includes a rotary power transfer element 133 being connected with the rotary shaft 120, a plurality of radial wheel units 134 being connected with the rotary power transfer element 133 and a yoke unit 135 being connected with the plurality of the radial wheel units 134. In one embodiment, the vacuum chamber 130 may further include a superconductive wire being arranged toward outside of the yoke unit 135 in the vacuum chamber 130, being horizontally spaced apart from one side of each of the first and second heat transfer elements 131 and 132 and being conduction cooled through each of the first and second heat transfer elements 131 and 132. In one embodiment, the rotary power transfer element 133 may be combined with outer surface of the rotary shaft 120 in the vacuum chamber 130. The plurality of the radial wheel units 134 are formed radially from the rotary power transfer element 133. The yoke unit 135 may be a rim being combined with the plurality of the radial wheel units 134 and may correspond to a metal pin of the vacuum chamber 130. In one embodiment, the plurality of the radial wheel units 134 are combined with both sides of the rotary power transfer element 133 and may transfer the rotary power toward the outside from the rotary power transfer element 133 to rotate inner elements of the vacuum chamber 130.

The heat transfer unit 140 includes a first cooling unit 141 and a second cooling unit 142. The first and second cooling units 141 and 142 respectively connects one side of the first and second heat transfer elements 131 and 132 and one of the both sides of the cyrocooler 110 in the rotary shaft 120. The heat transfer unit 140 conducts a heat to the cyrocooler 110 through the first and second cooling units 141 and 142 to be cooled.

The superconductive wire 136 is arranged toward outside of the yoke unit 135 in the vacuum chamber 130. The superconductive wire 136 becomes a material having the highest conductivity without electric resistance in a proper condition (e.g., in present invention, an extremely low temperature such as less than or equal to 20K). In general, when a current flows in a certain material, the certain material generates a heat with a value of multiplying a square of a current value by a resistance value of the certain material to cause energy loss but the superconductive wire 136 has no electric resistance to transfer a higher quantity of current to a distance without the energy loss. The superconductive wire 136 plays an important role on efficiency improvement of the conduction cooling type superconducting rotator 100. In one embodiment, the superconductive material 136 may be horizontally spaced apart from one side of each of the first and second heat transfer elements 131 and 132 and may be conduction cooled through each of the first and second heat transfer elements 131 and 132.

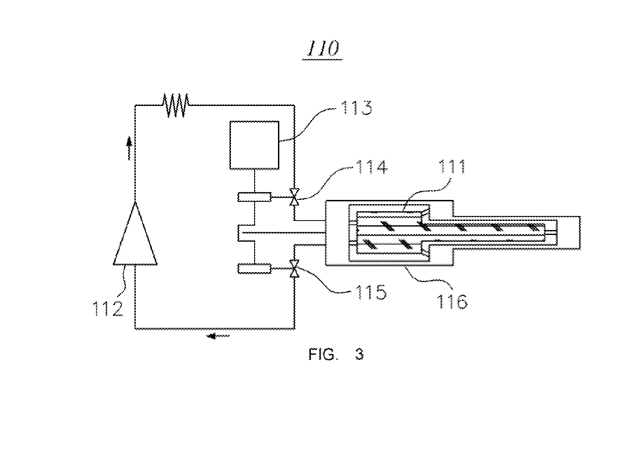

FIG. 3 is a diagram illustrating a cryocooler according to an example embodiment of the described technology.

Referring to FIG. 3, the cryocooler 110 corresponds to a GM (Gifford-McMahon) cooler and includes a regenerator 111, a compressor 112, a movable motor 113, an intake valve 114, a discharge valve 115 and a cylinder 116 and generally, uses a helium gas as the refrigerant. An operating procedure of the cryocooler 110 includes a constant volume compression process, an equivalent compression process, an isobaric transformation process, an equivalent expansion process and an isobaric transformation process and is used to helium re-condensing or thermal insulating surface cooling such as vacuum pump for manufacturing semiconductor, MRI, SMES or a superconducting generator. In the present invention, the cyrocooler 110 uses the GM (Gifford-McMahon) cooler but may use JT (Joule-Thompson) cooler, Brayton cooler, Stirling cooler or Pulse Tube cooler according to a structure and use of a rotator.

Although embodiments have been described with reference to a number of illustrative embodiments thereof, it should be understood that numerous other modifications and embodiments can be devised by those skilled in the art that will fall within the spirit and scope of the principles of this disclosure.

1. A conduction cooling type superconducting rotator comprising:
a cryocooler;
a rotary shaft including a columnar hail being spaced apart from the cryocooler to enclose the cryocooler and the rotary shaft configured to transfer a rotary power;
a vacuum chamber including columnar halls arranged at both sides of the rotary shaft, first and second heat transfer elements being connected with the cryocooler and a heat transfer unit conducting a heat to the cryocooler through the first and second heat transfer elements wherein inner surfaces of the columnar halls and outer surfaces of the rotary shaft connectedly rotates; and
first and second cooling units configured to connect the first and second heat transfer elements and the cryocooler.

2. The conduction cooling type superconducting rotator of claim 1, wherein each of the first and second heat transfer elements is curvedly formed toward first and second directions in the vacuum chamber.

3. The conduction cooling type superconducting rotator of claim 1, wherein the first and second heat transfer elements mainly include a copper as a conductor and cool the vacuum chamber.

4. The conduction cooling type superconducting rotator of claim 1, wherein the vacuum chamber further includes a rotary power transfer element, a plurality of radial wheel units and a yoke unit, the rotary power transfer element being connected with the rotary shaft, the plurality of the radial wheel units being connected with the rotary power transfer element, the yoke unit being connected with the plurality of the radial wheel units.

5. The conduction cooling type superconducting rotator of claim 4, wherein the vacuum chamber further includes a superconductive wire being arranged toward outside of the yoke unit in the vacuum chamber and being horizontally spaced apart from one side of each of the first and second heat transfer elements, the superconductive wire being conductively cooled through each of the first and second heat transfer elements.

6. The conduction cooling type superconducting rotator of claim 1, wherein the vacuum chamber is sequentially cooled in the first and second cooling unit, the first and second cooling unit being connected with the first and second heat transfer elements and the cryocooler.
